(19) United States
(12) Patent Application Publication
(10) Pub. No.: US 2018/0180870 A1
(43) Pub. Date: Jun. 28, 2018

(54) ROTARY DRIVE APPARATUS

(71) Applicant: Nidec Corporation, Kyoto (JP)

(72) Inventor: Junya MIZUKAMI, Kyoto (JP)

(21) Appl. No.: 15/725,364

(22) Filed: Oct. 5, 2017

(30) Foreign Application Priority Data
Dec. 27, 2016 (JP) 2016-252599

(51) Int. Cl. G02B 26/08; H02K 7/02; G02B 7/00

(52) U.S. Cl. CPC G02B 26/0816; G02B 7/008; H02K 7/02

(57) ABSTRACT

This rotary drive apparatus is arranged to rotate a mirror which reflects incident light coming from a light source, and includes a motor including a rotating portion arranged to rotate about a central axis extending in a vertical direction; a flywheel including the mirror, and rotatably held by the rotating portion; and an impeller directly or indirectly fixed to the rotating portion. The impeller includes a tubular blade support portion arranged to extend along the central axis, and a plurality of blades arranged in a circumferential direction on an outer circumferential surface of the blade support portion. The blade support portion includes an impeller through hole arranged to pass through the blade support portion in an axial direction. The blades are arranged between the light source and the motor. The impeller through hole is arranged to define a light path over which the incident light travels.

### CROSS REFERENCE TO RELATED APPLICATIONS

This application claims the benefit of priority to Japanese Patent Application No. 2016-252599 filed on Dec. 27, 2016. The entire contents of this application are hereby incorporated herein by reference.

### BACKGROUND OF THE INVENTION

### 1. Field of the Invention

The present invention relates to a rotary drive apparatus.

### 2. Description of the Related Art

A light source, a rotating body arranged to cause a mirror to reflect light emitted from the light source and emit resulting reflected light to a surrounding space to irradiate a target object therewith, and a motor arranged to rotatably support the rotating body are typically installed in a scanner apparatus which is used in a head-mounted display (HMD) or the like to perform position recognition. Such an apparatus that causes light emitted from a light source to be reflected and emitted to a surrounding space is described in, for example, JP-A 2010-277789.

In the apparatus described in JP-A 2010-277789, a blower fan is arranged to reduce heat damage caused to parts on an LED board by an increase in temperature of surroundings of an LED light source. A disk, to which this blower fan is attached, is caused to rotate by a driving mechanism, and wind taken in by blades of the blower fan is blown against the LED light source to cool the LED light source and the surroundings thereof. However, the disk is caused to rotate by a motor of the driving mechanism through a pinion, and accordingly, the rotation rate of the disk is low. This may lead to a poor cooling effect.

### SUMMARY OF THE INVENTION

A rotary drive apparatus according to a preferred embodiment of the present invention is arranged to rotate a mirror which reflects incident light coming from a light source, and includes a motor including a rotating portion arranged to rotate about a central axis extending in a vertical direction; a flywheel including the mirror, and rotatably held by the rotating portion; and an impeller directly or indirectly fixed to the rotating portion. The impeller includes a tubular blade support portion arranged to extend along the central axis, and a plurality of blades arranged in a circumferential direction on an outer circumferential surface of the blade support portion. The blade support portion includes an impeller through hole arranged to pass through the blade support portion in an axial direction. The blades are arranged between the light source and the motor. The impeller through hole is arranged to define a light path over which the incident light travels.

According to the above preferred embodiment of the present invention, the impeller is arranged between the light source and the motor, and rotation of the motor is used to cause the impeller to rotate at a high rotation rate to cool the light source and surroundings of the light source with high efficiency. This contributes to preventing an excessive increase in temperature of an interior of the rotary drive apparatus, and reducing deterioration of parts in the rotary drive apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a rotary drive apparatus according to a first preferred embodiment of the present invention.

FIG. 2 is a vertical sectional view of the rotary drive apparatus according to the first preferred embodiment.

FIG. 3 is a vertical sectional view of a rotary drive apparatus according to a modification of the first preferred embodiment.

FIG. 4 is a vertical sectional view of a rotary drive apparatus according to a modification of the first preferred embodiment.

FIG. 5 is a vertical sectional view of a rotary drive apparatus according to a modification of the first preferred embodiment.

FIG. 6 is a vertical sectional view of a rotary drive apparatus according to a modification of the first preferred embodiment.

FIG. 7 is a vertical sectional view of a rotary drive apparatus according to a modification of the first preferred embodiment.

FIG. 8 is a perspective view of a rotary drive apparatus according to a modification of the first preferred embodiment.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of a motor, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper side are not meant to restrict in any way the orientation of a rotary drive apparatus according to any preferred embodiment of the present invention when in use.

Also note that the term “parallel” as used herein includes both “parallel” and “substantially parallel”. Also note that the term “perpendicular” as used herein includes both “perpendicular” and “substantially perpendicular”.

### 1. First Preferred Embodiment

### 1-1. Structure of Rotary Drive Apparatus

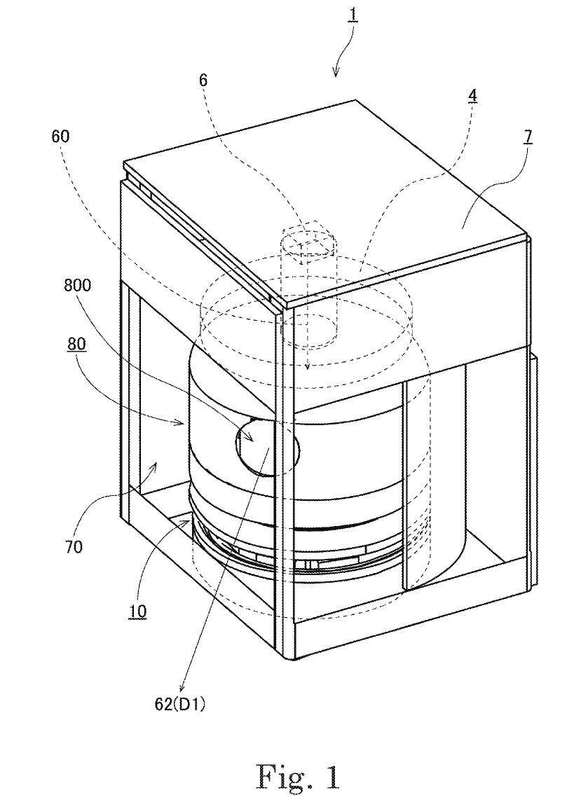

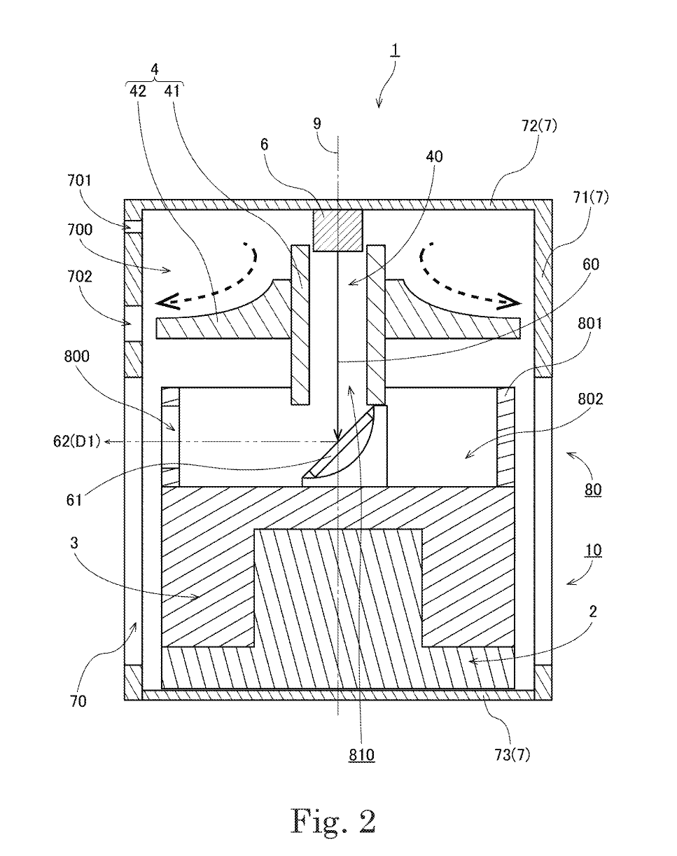

FIG. 1 is a perspective view of a rotary drive apparatus according to a first preferred embodiment of the present invention. FIG. 2 is a vertical sectional view of the rotary drive apparatus 1 according to the first preferred embodiment. The rotary drive apparatus 1 is an apparatus arranged to rotate a mirror 61, which is arranged to reflect incident light 60 coming from a light source 6 and at least a portion of which is arranged on a central axis 9, and emit reflected light 62 obtained by the mirror 61 reflecting the incident light 60 to an outside of the rotary drive apparatus 1 through a lens while rotating the mirror 61, which will be described below. In the present preferred embodiment, the light source 6 and a frame 7, on which the light source 6 is installed, are arranged in the rotary drive apparatus 1.

Referring to FIGS. 1 and 2, the rotary drive apparatus 1 includes a motor 10, a flywheel 80, an impeller 4, and the frame 7.

### 1-2. Structure of Motor

First, the structure of the motor 10 will now be described below.

The motor 10 includes a stationary portion 2 including a stator, and a rotating portion 3 including a magnet. The stationary portion 2 is arranged to be stationary relative to a case or the like in which the rotary drive apparatus 1 is arranged. In addition, the stationary portion 2 is arranged on and fixed to an upper surface of a lower surface plate 73 of the frame 7, which will be described below. The rotating portion 3 is supported through a bearing portion (not shown) to be rotatable about the central axis 9, which extends in the vertical direction, with respect to the stationary portion 2.

Once electric drive currents are supplied to coils included in the stationary portion 2, magnetic flux is generated around each of a plurality of teeth, which are magnetic cores for the coils. Then, interaction between the magnetic flux of the teeth and magnetic flux of the magnet included in the rotating portion 3 produces a circumferential torque between the stationary portion 2 and the rotating portion 3, so that the rotating portion 3 is caused to rotate about the central axis 9 with respect to the stationary portion 2. Thus, the flywheel 80, which is rotatably held by the rotating portion 3, and the impeller 4, which is directly or indirectly fixed to the rotating portion 3, are caused to rotate about the central axis 9 together with the rotating portion 3.

As the bearing portion (not shown), a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion (not shown).

### 1-3. Structure of Flywheel

Next, the structure of the flywheel 80 will now be described below.

Referring to FIGS. 1 and 2, the flywheel 80 is supported by an upper end portion of the rotating portion 3 of the motor 10, and is arranged to rotate about the central axis 9 together with the rotating portion 3. The flywheel 80 is fixed to an upper surface of the rotating portion 3 through, for example, engagement, an adhesive, or the like. The flywheel 80 includes a tubular portion 801, the mirror 61, and a hollow portion 802. The hollow portion 802 is a cavity defined in the flywheel 80. A resin, for example, is used as a material of the flywheel 80.

The tubular portion 801 is a cylindrical member arranged to extend along the central axis 9. A portion of the tubular portion 801 includes a through hole 800 arranged to pass therethrough in a first radial direction D1, which will be described below. The lens is fitted and fixed in the through hole 800.

An upper surface of the flywheel 80 includes a through hole 810 arranged to pass through at least a portion or a whole of the upper surface in the axial direction, the through hole 810 extending on and around the central axis 9. A portion, including a lower end portion, of a blade support portion 41 of the impeller 4, which will be described below, is inserted in the through hole 810, and is fixed to a resin member of the flywheel 80.

At least a portion of the mirror 61 is arranged on the central axis 9. The mirror 61 is fixed to the resin member of the flywheel 80. In addition, the mirror 61 is inclined at an angle of 45° with respect to the axial direction and the first radial direction D1, which will be described below. A fully reflective mirror, for example, is used as the mirror 61.

The incident light 60, which is emitted from the light source 6, comes from above the upper surface of the flywheel 80, passes through the through hole 810, and travels downward along the central axis 9 in the hollow portion 802 radially inside of the tubular portion 801. The incident light 60 is then reflected by the mirror 61, and then travels in the first radial direction D1 in the hollow portion 802, and is emitted to the outside of the rotary drive apparatus 1 through the lens fitted in the through hole 800 of the tubular portion 801.

The mirror 61 of the flywheel 80 is arranged to reflect the incident light 60 from the light source 6 and emit the reflected light 62 to the outside while rotating about the central axis 9 together with the rotating portion 3 of the motor 10. As a result, a wide range can be irradiated with light. Note that an outer circumferential surface of the flywheel 80 has a reflectivity lower than that of a surface of the mirror 61. This contributes to preventing diffuse reflection of the incident light 60 from the light source 6.

Note that the rotary drive apparatus 1 may further include, in addition to the flywheel 80 arranged to emit the reflected light 62 to the outside in the first radial direction D1, another flywheel (not shown) which is arranged to emit reflected light to the outside in a second radial direction different from the first radial direction D1, and which is arranged, for example, below the motor 10 like a flywheel in a modification of the present preferred embodiment, which will be described below. In this case, a half mirror the transmissivity and reflectivity of which are substantially equal may be used as the mirror 61. In this case, a half of the incident light 60 on the mirror 61 is reflected and emitted in the first radial direction D1, and the other half of the incident light 60 passes through the mirror 61 and travels further downward, and is reflected by a mirror (not shown) of the lower flywheel to be emitted in the second radial direction. When light is emitted out in the two different directions, i.e., the first radial direction D1 and the second radial direction, light beams that are emitted out in the two different directions take different times to reach an object to be irradiated with light while the motor 10 is rotating, and this makes it possible to precisely recognize the three-dimensional position of the object in a space. Note that the other flywheel may be arranged either in the rotary drive apparatus 1 including the flywheel 80, or in another rotary drive apparatus (not shown).

### 1-4. Structures of Impeller and Frame

Next, the structures of the impeller 4 and the frame 7 will now be described below.

The impeller 4 includes the blade support portion 41 and a plurality of blades 42. The blade support portion 41 is a tubular portion arranged to extend along the central axis 9. The blades 42 are arranged in a circumferential direction on an outer circumferential surface of the blade support portion 41.

The impeller 4, which includes the blade support portion 41 and the blades 42, is arranged between the motor 10 and the light source 6. In addition, referring to FIG. 2, at least a portion, including the lower end portion, of the blade support portion 41 is inserted in the through hole 810 defined in the upper surface of the flywheel 80, and is fixed to the flywheel 80. Press fitting, adhesion, or welding, for example, is used to fix the blade support portion 41 to the flywheel 80. Thus, the impeller 4 is supported by the rotating portion 3 of the motor 10 through the flywheel 80, and is arranged to rotate about the central axis 9 together with the rotating portion 3. That is, the impeller 4 is arranged to rotate at a rotation rate equal to that of the rotating portion 3 of the motor 10. A large rotation rate of the impeller 4 can be achieved by using rotation of the motor 10 to rotate the impeller 4 as described above. Thus, the light source 6 and surroundings of the light source 6 can be cooled with high efficiency. This contributes to preventing an excessive increase in temperature of an interior of the rotary drive apparatus 1, and reducing deterioration of parts in the rotary drive apparatus 1.

In addition, the impeller 4 is arranged between the flywheel 80, which is supported by an upper portion of the motor 10, and the light source 6. Further, an axial distance between the flywheel 80 and the light source 6 is arranged to be greater than an axial dimension of each of the blades 42. In addition, an axial distance between each of the blades 42 and the light source 6 is arranged to be shorter than an axial distance between each of the blades 42 and the flywheel 80. The distance between the impeller 4 and the light source 6 is thus reduced to allow the light source 6 and the surroundings of the light source 6 to be cooled with high efficiency.

Further, the blade support portion 41 includes an impeller through hole 40 arranged to pass through the blade support portion 41 in the axial direction. At least a portion of the light source 6 is arranged in the impeller through hole 40 above the blades 42. This contributes to reducing direct impingement of air flows generated by rotation of the blades 42 on the light source 6, and reducing deterioration of the light source 6 due to accumulation of dust or the like.

As described above, at least a portion, including the lower end portion, of the blade support portion 41 is inserted in the through hole 810 defined in the upper surface of the flywheel 80. The impeller through hole 40 is arranged to define a light path over which the incident light 60 travels. That is, the incident light 60, which is emitted from the light source 6, travels from above the blades 42 downward along the central axis 9, passes through the impeller through hole 40, and, further, travels downward in the hollow portion 802 radially inside of the tubular portion 801, and is reflected by the mirror 61.

The frame 7 is fixed to the case or the like in which the rotary drive apparatus 1 is arranged. The frame 7 includes a side wall portion 71, an upper surface plate 72, and the lower surface plate 73.

The side wall portion 71 is a tubular member arranged to extend along the central axis 9. The side wall portion 71 is arranged to partially join an outer edge portion of the upper surface plate 72 and an outer edge portion of the lower surface plate 73 to each other, and is arranged to accommodate at least a portion of the impeller 4, the motor 10, and the flywheel 80 radially inside thereof. In particular, a lowermost portion of the impeller 4, the motor 10, and the flywheel 80 (which is a lower portion of the motor 10 in the present preferred embodiment) is completely accommodated radially inside of the side wall portion 71, and is securely held.

The side wall portion 71 of the frame 7 includes an opening portion 70. At least a portion of the outer circumferential surface of the flywheel 80 is exposed to the outside through the opening portion 70. In particular, the lens (not shown), through which the reflected light 62 passes, is held in the through hole 800, which is defined in an outer circumferential portion of the flywheel 80. While the flywheel 80 is rotating, the lens periodically faces the opening portion 70 of the frame 7. This allows the reflected light 62 to be emitted outward beyond the frame 7.

The upper surface plate 72 is a member arranged to extend radially inward from an upper end of the side wall portion 71. The light source 6 is fixed to a lower surface of the upper surface plate 72 and on the central axis 9 through, for example, an adhesive. At least a portion, including an upper end, of the light source 6 is completely accommodated radially inside of the side wall portion 71 of the frame 7. The light source 6 is thus securely held.

In addition, the lower surface plate 73 is a member arranged to extend radially inward from a lower end of the side wall portion 71. The stationary portion 2 of the motor 10 is arranged on and fixed to the upper surface of the lower surface plate 73.

Referring to FIG. 2, the frame 7 further includes a first slit 701 and a second slit 702 in addition to the opening portion 70. The first slit 701 is arranged to pass through at least a portion of the frame 7 to join a space outside of the frame 7 and a space inside of the frame 7 to each other to allow gas (e.g., air) to pass therebetween. The second slit 702 is arranged to pass through at least a portion of the frame 7 axially below the first slit 701 to join the space outside of the frame 7 and the space inside of the frame 7 to each other to allow gas to pass therebetween. This allows gas to efficiently circulate in the space inside of the frame 7. In the present preferred embodiment, in the side wall portion 71 of the frame 7, each of the first slit 701 and the second slit 702 is arranged to extend in such a direction as to pass through the side wall portion 71 in a radial direction. In addition, it is desirable that an axial position of the second slit 702 be arranged to overlap with an axial position of each of the blades 42 of the impeller 4. This allows gas flowing in the circumferential direction in an air channel 700 between the impeller 4 and the side wall portion 71 to be efficiently discharged to the outside through the second slit 702, as described below. Note, however, that each of the first slit 701 and the second slit 702 may alternatively be arranged at any other desirable position. For example, one or both of the first slit 701 and the second slit 702 may alternatively be defined in the upper surface plate 72 of the frame 7, and be arranged to extend in such a direction as to pass through the upper surface plate 72 in the axial direction.

Next, the flow of gas inside of the frame 7 will now be described below. As described above, the side wall portion 71 of the frame 7 includes the first slit 701 and the second slit 702, each of which is defined at one circumferential position, radially outside of and in the vicinity of the impeller 4. In the present preferred embodiment, the first slit 701 defines an air inlet, while the second slit 702 defines an air outlet. Then, the first slit 701, the second slit 702, and the impeller 4 together define a centrifugal fan configuration. Note that it is desirable that the second slit 702 be arranged to have an axial dimension greater than that of the first slit 701, or to have an opening area greater than that of the first slit 701. This similarly allows the gas flowing in the circumferential direction in the air channel 700 to be efficiently discharged to the outside through the second slit 702. In addition, it is desirable that at least a portion of the first slit 701 be arranged at a level higher than that of the impeller 4.

Once the rotary drive apparatus 1 is driven, the impeller 4 is caused to rotate together with the rotating portion 3 of the motor 10. Then, gas (e.g., air) is radially taken into the space inside of the frame 7 through the first slit 701, which defines the air inlet. Thus, the gas, taken from above the impeller 4 into the space inside of the frame 7, receives a centrifugal force caused by the impeller 4, and flows in the circumferential direction in the air channel 700 between the impeller 4 and the side wall portion 71. Then, the gas is discharged out of the frame 7 through the second slit 702, which defines the air outlet.

Since the gas is taken in through the first slit 701, which is arranged in the vicinity of the light source 6, and is discharged to the outside through the second slit 702, which is arranged at a greater distance from the light source 6, heat of the light source 6 and the surroundings of the light source 6 can be absorbed by the gas taken in through the first slit 701 and be transferred to a distant position to eliminate the heat. Thus, the light source 6 and the surroundings of the light source 6 can be cooled with high efficiency. This contributes to preventing an excessive increase in the temperature of the interior of the rotary drive apparatus 1, and reducing the deterioration of the parts in the rotary drive apparatus 1.

Note that the air inlet and the air outlet may be reversed. That is, the centrifugal fan configuration may alternatively be defined by the impeller 4 and the first and second slits 701 and 702 serving as an air outlet and an air inlet, respectively. In this case, the impeller 4 is arranged upside down. Then, gas is radially taken into the space inside of the frame 7 through the second slit 702, which defines the air inlet, and the gas receives the centrifugal force caused by the impeller 4, and flows in the circumferential direction in the air channel 700 between the impeller 4 and the side wall portion 71 to be discharged out of the frame 7 through the first slit 701, which defines the air outlet. Since at least a portion of the light source 6 is arranged above the impeller 4, the light source 6 and the surroundings of the light source 6 can be cooled with high efficiency by impingement of the gas taken in through the second slit 702. This contributes to preventing an excessive increase in the temperature of the interior of the rotary drive apparatus 1, and reducing the deterioration of the parts in the rotary drive apparatus 1.

### 2. Example Modifications

While a preferred embodiment of the present invention has been described above, it is to be understood that the present invention is not limited to the above-described preferred embodiment.

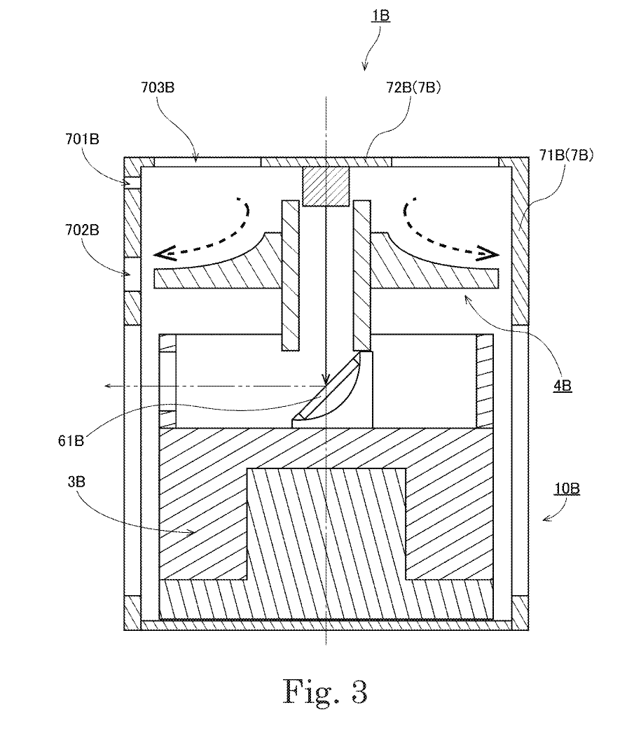

FIG. 3 is a vertical sectional view of a rotary drive apparatus 1B according to a modification of the first preferred embodiment. In the modification illustrated in FIG. 3, a frame 7B includes a third slit 703B in addition to a first slit 701B and a second slit 702B each of which is arranged to pass through a side wall portion 71B. The third slit 703B is arranged to pass through an upper surface plate 72B in the axial direction to join a space outside of the frame 7B and a space inside of the frame 7B to each other to allow gas to pass therebetween. In a centrifugal fan configuration defined by the first slit 701B, the second slit 702B, and an impeller 4B, the third slit 703B is additionally arranged to perform a function as an air inlet or an air outlet to allow gas to circulate with higher efficiency while the impeller 4B is rotating together with a rotating portion 3B of a motor 10B.

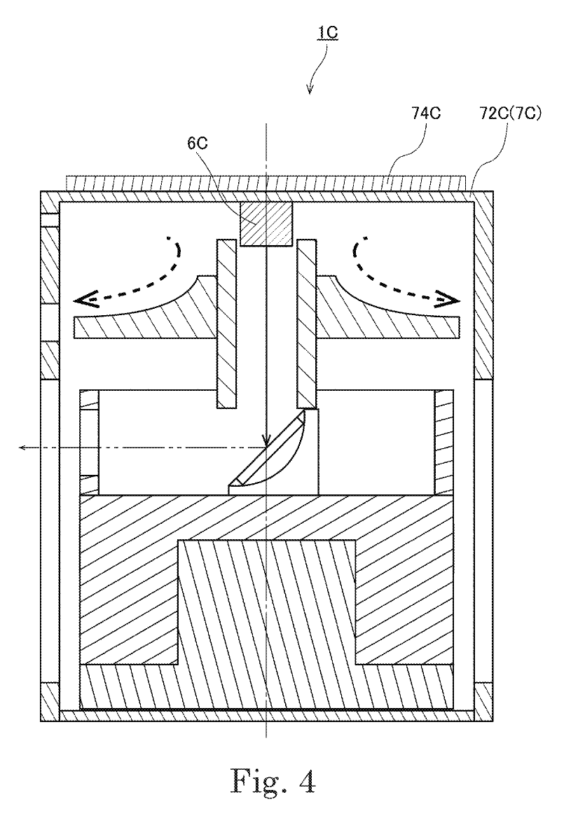

FIG. 4 is a vertical sectional view of a rotary drive apparatus 1C according to another modification of the first preferred embodiment. In the modification illustrated in FIG. 4, a metal sheet 74C is attached to at least a portion of an outer wall of a frame 7C (in the present modification, an upper surface of an upper surface plate 72C). At least a portion of the metal sheet 74C is arranged at a level higher than that of a light source 6C. When the metal sheet 74C, which has a high thermal conductivity, is attached to the outer wall of the frame 7C in the vicinity of the light source 6C as described above, the metal sheet 74C functions as a heat sink. More specifically, heat transferred from the light source 6C to the frame 7C in the vicinity of the light source 6C can be efficiently discharged out of the rotary drive apparatus 1C through temperature exchange between the metal sheet 74C and external gas.

Note that at least a portion of the frame 7C in the vicinity of the light source 6C may be made of a metal material instead of or in addition to the metal sheet 74C being attached to the outer wall of the frame 7C. When a portion of the frame 7C is made of a metal, this portion can function as a heat sink. More specifically, heat transferred from the light source 6C to the frame 7C in the vicinity of the light source 6C can be efficiently discharged out of the rotary drive apparatus 1C through temperature exchange between the frame 7C and the external gas.

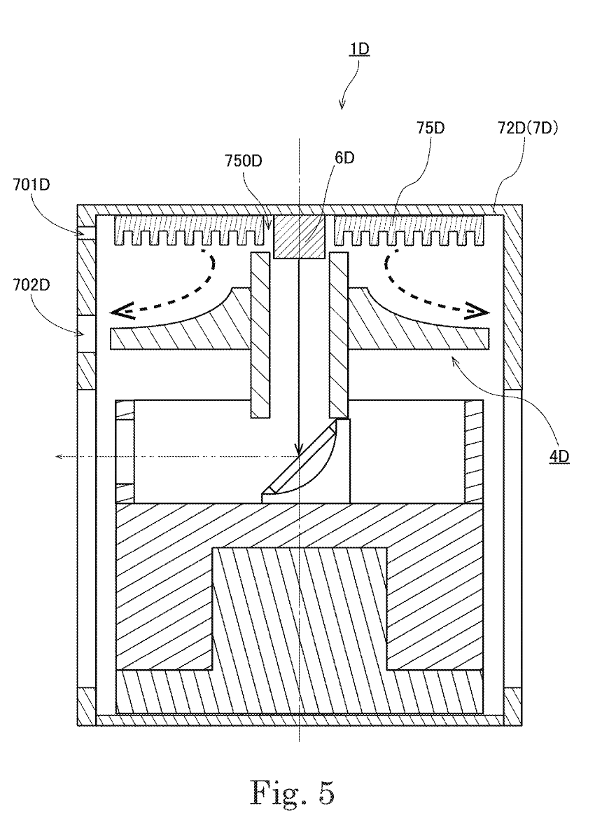

FIG. 5 is a vertical sectional view of a rotary drive apparatus 1D according to yet another modification of the first preferred embodiment. In the modification illustrated in FIG. 5, a heat sink portion 75D is attached to at least a portion of a lower surface of an upper surface plate 72D of a frame 7D. The heat sink portion 75D is a member in the shape of a circular ring and including a plurality of fins having a high thermal conductivity, and is arranged radially outside of a light source 6D and above an impeller 4D. Since the heat sink portion 75D, which has a high thermal conductivity and has a large surface area in contact with gas inside of the frame 7D, is arranged on the lower surface of the upper surface plate 72D as described above, heat transferred from the light source 6D to the frame 7D in the vicinity of the light source 6D can be efficiently transferred to the gas inside of the frame 7D. As a result, the heat can be discharged to the outside together with the gas with increased efficiency by a centrifugal fan configuration defined by the impeller 4D, a first slit 701D, and a second slit 702D.

It is desirable that the heat sink portion 75D include a hollow portion 750D arranged to pass through the heat sink portion 75D in the axial direction around the light source 6D. In addition, at least a portion of the light source 6D is preferably arranged in the hollow portion 750D. This contributes to reducing direct impingement of air flows generated by rotation of the impeller 4D on the light source 6D, and reducing deterioration of the light source 6D due to accumulation of dust or the like.

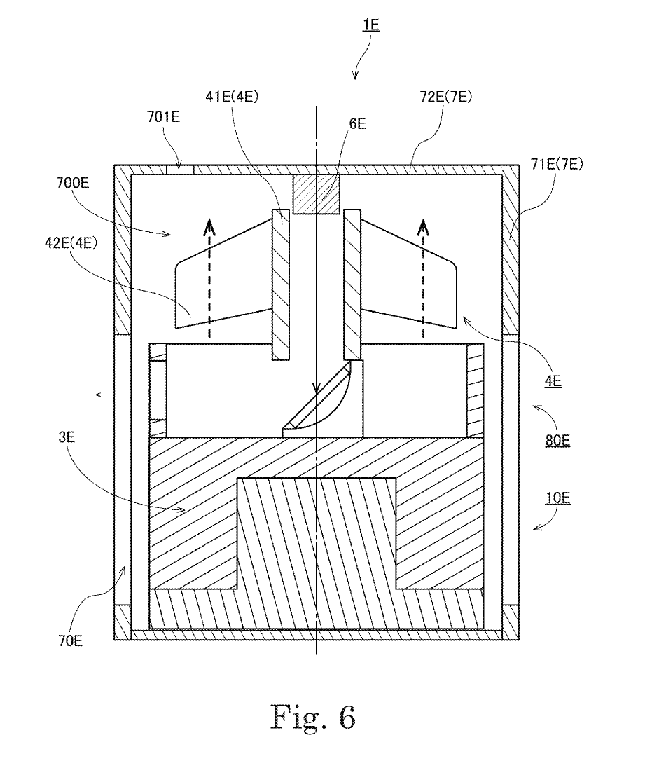

FIG. 6 is a vertical sectional view of a rotary drive apparatus 1E according to yet another modification of the first preferred embodiment. In the modification illustrated in FIG. 6, an axial fan configuration is defined by an opening portion 70E defined in a side wall portion 71E of a frame 7E, a first slit 701E defined in an upper surface plate 72E, and an impeller 4E. The opening portion 70E is defined in a manner similar to that in which the opening portion 70 is defined in the first preferred embodiment, and at least a portion of an outer circumferential surface of a flywheel 80E is exposed to an outside through the opening portion 70E. In addition, in the upper surface plate 72E of the frame 7E, the first slit 701E is arranged to pass through the upper surface plate 72E in the axial direction.

As with the impeller 4 according to the first preferred embodiment, the impeller 4E is supported by a rotating portion 3E of a motor 10E through the flywheel 80E. A plurality of blades 42E of the impeller 4E are arranged at substantially regular intervals in the circumferential direction around a blade support portion 41E. Note that the number of blades is not limited to particular values. In the present modification, the opening portion 70E defines an air inlet, while the first slit 701E defines an air outlet.

The impeller 4E rotates together with the rotating portion 3E of the motor 10E, and this causes gas to be taken into a space inside of the frame 7E through the opening portion 70E, which defines the air inlet below the impeller 4E. Then, the gas flows axially upward in an air channel 700E between the impeller 4E and the side wall portion 71E, and is discharged out of the frame 7E through the first slit 701E, which defines the air outlet. As illustrated in FIG. 6, at least a portion of a light source 6E is arranged at a level higher than that of the impeller 4E, and the light source 6E and surroundings of the light source 6E can be cooled with high efficiency by impingement of the gas taken in from below the impeller 4E and traveling in an upward direction. This contributes to preventing an excessive increase in temperature of an interior of the rotary drive apparatus 1E, and reducing deterioration of parts in the rotary drive apparatus 1E.

Note that the air inlet and the air outlet may be reversed. That is, the axial fan configuration may alternatively be defined by the impeller 4E and the first slit 701E and the opening portion 70E serving as an air inlet and an air outlet, respectively. In this case, the impeller 4E is arranged upside down. Then, gas is taken into the space inside of the frame 7E through the first slit 701E, which defines the air inlet in the vicinity of the light source 6E. Then, the gas flows axially downward in the air channel 700E between the impeller 4E and the side wall portion 71E, and is discharged out of the frame 7E through the opening portion 70E, which defines the air outlet. Thus, the gas is taken in through the first slit 701E, which is arranged in the vicinity of the light source 6E, and is discharged to the outside through the opening portion 70E, which is arranged at a greater distance from the light source 6E, and as a result, heat of the light source 6E and the surroundings of the light source 6E can be absorbed by the gas taken in through the first slit 701E and be transferred to a distant position to eliminate the heat. Thus, the light source 6E and the surroundings of the light source 6E can be cooled with high efficiency. This contributes to preventing an excessive increase in the temperature of the interior of the rotary drive apparatus 1E, and reducing the deterioration of the parts in the rotary drive apparatus 1E.

Further, a rotary drive apparatus according to a preferred embodiment of the present invention may include a plurality of fan configurations. The plurality of fan configurations may be arranged to have either the same configuration or different configurations. For example, the rotary drive apparatus 1 according to the first preferred embodiment may alternatively include a first impeller, which is the impeller 4 supported by the rotating portion 3 of the motor 10, and a second impeller (not shown) which includes a plurality of second blades (not shown) arranged in the circumferential direction, and which is supported by the rotating portion 3 of the motor 10 at an axial position different from that of the first impeller. That is, the first impeller and the second impeller may be arranged to define a centrifugal fan configuration and an axial fan configuration, respectively. Provision of the plurality of fan configurations allows gas to circulate with increased efficiency in the space inside of the frame 7. Thus, the light source 6 and the surroundings of the light source 6 can be cooled with higher efficiency.

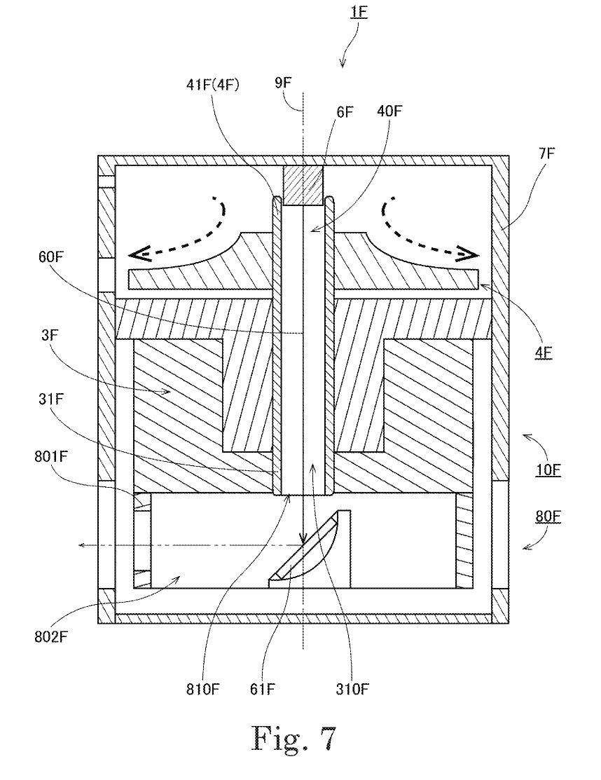

FIG. 7 is a vertical sectional view of a rotary drive apparatus 1F according to yet another modification of the first preferred embodiment. In the modification illustrated in FIG. 7, a flywheel 80F is arranged below a motor 10F. A rotating portion 3F of the motor 10F includes a cylinder shaft 31F arranged to extend in the axial direction along a central axis 9F. An upper end portion of the shaft 31F is arranged to extend toward an impeller 4F, and is defined integrally with a blade support portion 41F of the impeller 4F. Note, however, that the shaft 31F and the blade support portion 41F may alternatively be defined by separate members. In addition, the shaft 31F includes a shaft through hole 310F arranged to pass through the shaft 31F in the axial direction. The shaft through hole 310F is defined continuously with and below an impeller through hole 40F, which is arranged pass through the blade support portion 41F in the axial direction. Note that the shaft through hole 310F and the impeller through hole 40F may alternatively be arranged to have different radial dimensions.

The flywheel 80F is supported by a lower end portion of the rotating portion 3F of the motor 10F, and is arranged to rotate about the central axis 9F together with the rotating portion 3F. The flywheel 80F is fixed to a lower surface of the rotating portion 3F through, for example, engagement, an adhesive, or the like. The flywheel 80F includes a cylindrical tubular portion 801F arranged to extend along the central axis 9F, a mirror 61F, and a hollow portion 802F. An upper surface of the flywheel 80F includes a through hole 810F arranged to pass through at least a portion or a whole of the upper surface in the axial direction, the through hole 810F extending on and around the central axis 9F.

The impeller through hole 40F and the shaft through hole 310F are arranged to define a light path over which incident light 60F travels. Specifically, the incident light 60F, which is emitted from a light source 6F, travels downward in the impeller through hole 40F and the shaft through hole 310F, and then, passing through the through hole 810F defined in the upper surface of the flywheel 80F, travels downward in the hollow portion 802F, and is reflected by the mirror 61F. As described above, in the configuration illustrated in FIG. 7, the impeller 4F and the flywheel 80F are arranged above and below, respectively, the motor 10F, and accordingly, a center of gravity of the rotating portion 3F of the motor 10F, the impeller 4F, and the flywheel 80F, which are members of the rotary drive apparatus 1F which are arranged to rotate about the central axis 9F, lies near a center of gravity of the motor 10F, which is a driving source. This allows balance to be easily kept during rotation to achieve a stable posture during the rotation.

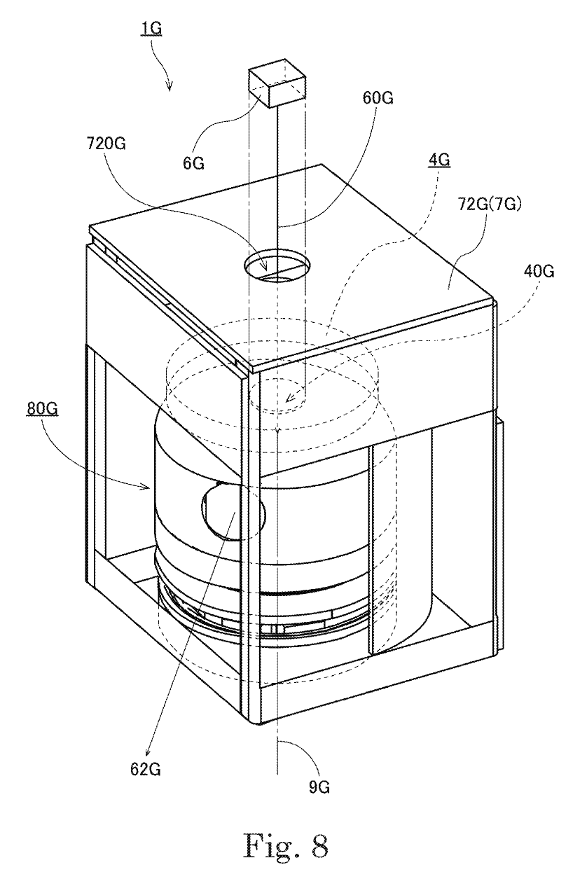

FIG. 8 is a perspective view of a rotary drive apparatus 1G according to yet another modification of the first preferred embodiment. As in the modification illustrated in FIG. 8, a light source 6G may be arranged outside of the rotary drive apparatus 1G. In addition, at least a portion of the light source 6G is arranged on a central axis 9G. Further, an upper surface plate 72G of a frame 7G includes a through hole 720G arranged to pass through the upper surface plate 72G in the axial direction around the central axis 9G. Incident light 60G emitted from the light source 6G travels from above the frame 7G downward along the central axis 9G, passes through the through hole 720G and an impeller through hole 40G of an impeller 4G, and is then reflected by a mirror (not shown) of a flywheel 80G, and resulting reflected light 62G is emitted out.

Note that the position of each slit defined in the frame may be different from the position thereof according to each of the above-described preferred embodiment and the modifications thereof. Also note that the flow of gas inside of the frame may be different from the flow thereof according to each of the above-described preferred embodiment and the modifications thereof.

Also note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus arranged to rotate a mirror which reflects incident light coming from a light source, the rotary drive apparatus comprising:
a motor including a rotating portion arranged to rotate about a central axis extending in a vertical direction;
a flywheel including the mirror, and rotatably held by the rotating portion; and
an impeller directly or indirectly fixed to the rotating portion; wherein
the impeller includes:
a tubular blade support portion arranged to extend along the central axis; and
a plurality of blades arranged in a circumferential direction on an outer circumferential surface of the blade support portion;
the blade support portion includes an impeller through hole arranged to pass through the blade support portion in an axial direction;
the blades are arranged between the light source and the motor; and
the impeller through hole is arranged to define a light path over which the incident light travels.

2. The rotary drive apparatus according to claim 1, wherein an axial distance between each of the blades and the light source is arranged to be shorter than an axial distance between each of the blades and the flywheel.

3. The rotary drive apparatus according to claim 1, further comprising a tubular frame arranged to extend along the central axis, wherein the frame is arranged to accommodate at least a portion of the impeller, the motor, and the flywheel radially inside thereof.

4. The rotary drive apparatus according to claim 3, wherein the frame is arranged to accommodate a lowermost portion of the impeller, the motor, and the flywheel radially inside thereof.

5. The rotary drive apparatus according to claim 3, wherein
the frame includes an opening portion; and
at least a portion of an outer circumferential surface of the flywheel is exposed through the opening portion.

6. The rotary drive apparatus according to claim 3, wherein
at least a portion of the light source is arranged on the central axis; and
the frame is further arranged to accommodate at least a portion of the light source radially inside thereof.

7. The rotary drive apparatus according to claim 3, wherein the frame includes a slit arranged to pass through at least a portion of the frame to join a space outside of the frame and a space inside of the frame to each other to allow gas to pass therebetween.

8. The rotary drive apparatus according to claim 3, further comprising a metal sheet attached to at least a portion of an outer wall of the frame, and having at least a portion thereof arranged at a level higher than that of the light source.

9. The rotary drive apparatus according to claim 3, wherein at least a portion of the frame is made of a metal.

10. The rotary drive apparatus according to claim 6, wherein at least a portion of the light source is arranged in the impeller through hole above the blades.

11. The rotary drive apparatus according to claim 6, further comprising a heat sink portion in a shape of a circular ring, including a plurality of fins having thermal conductivity, and arranged above the impeller, wherein
the heat sink portion includes a hollow portion arranged to pass through the heat sink portion in the axial direction; and
at least a portion of the light source is arranged in the hollow portion.

12. The rotary drive apparatus according to claim 1, wherein an axial distance between the flywheel and the light source is arranged to be greater than an axial dimension of each of the blades.

13. The rotary drive apparatus according to claim 1, wherein
the impeller is arranged to define a centrifugal fan configuration; and
at least a portion of the light source is arranged above the impeller.

14. The rotary drive apparatus according to claim 1, wherein
the impeller is arranged to define an axial fan configuration; and
at least a portion of the light source is arranged above the impeller.

15. The rotary drive apparatus according to claim 1, wherein
the motor includes a cylinder shaft arranged to extend along the central axis;
the shaft includes a shaft through hole arranged to pass through the shaft in the axial direction;
the flywheel is arranged below the motor; and
the impeller through hole and the shaft through hole are arranged to define a light path over with the incident light travels.

16. The rotary drive apparatus according to claim 1, comprising:
a first impeller being the impeller; and
a second impeller arranged at an axial position different from that of the first impeller, and including a plurality of second blades arranged in the circumferential direction; wherein
the first impeller is arranged to define a centrifugal fan configuration; and
the second impeller is arranged to define an axial fan configuration.
